(19) United States
(12) Patent Application Publication
(10) Pub. No.: US 2007/0080621 A1
(43) Pub. Date: Apr. 12, 2007

(54) Connecting structure of LCD shielding screen for welding mask

(76) Inventor: Moon Young Huh, Seoul (KR)

Correspondence Address: CANTOR COLBURN, LLP, 55 GRIFFIN ROAD SOUTH, BLOOMFIELD, CT, 06002, US

(21) Appl. No.: 11/396,804

(22) Filed: Apr. 3, 2006

(30) Foreign Application Priority Data
Oct. 7, 2005 (KR) 20-2005-0028624

(51) Int. Cl. H01J 29/80

(52) U.S. Cl. 313/402

(57) ABSTRACT

A connecting structure of an LCD shielding screen for a welding mask, in which the LCD shielding screen for protecting user's eyes from harmful rays generated during a welding operation is connected to a welding plane having a transparent window formed through the front surface thereof for covering a user's whole face, includes hook protrusions extended outwardly from both symmetric terminals of the LCD shielding screen; and rotary connecting pieces axially installed at both sides of the transparent window of the welding plane so that the rotary connecting pieces are connected to the corresponding hook protrusions of the LCD shielding screen. Thereby, the LCD shielding screen is simply attached to and detached from the welding plane of the welding mask, and is safely connected to the welding plane of the welding mask.

### BACKGROUND OF THE INVENTION

1. Field of the Invention

The present invention relates to a welding mask put on by a user during a welding process for protecting user's eyes and face, and more particularly to a connecting structure of an LCD shielding screen for a welding mask, in which the LCD shielding screen is simply attached to and detached from a welding plane of the welding mask and the LCD shielding screen is safely connected to the welding plane.

2. Description of the Related Art

Generally, various welding operations generate several dangers, such as strong harmful rays and splashing of base metal onto a user's face due to momentary heat of a high temperature and resistance. Accordingly, it is well known that a welding mask for protecting user's eyes and face from the above dangers during welding is used.

Such a welding mask comprises a welding plane having a transparent window formed through the front surface thereof for covering a user's whole face, a wearable band put on by a user at his/her head and connected to the welding plane using a rotary shaft for rotating the welding plane up and down at a designated angle, and an LCD shielding screen installed in the rear of the transparent window of the welding plane for protecting user's eyes from harmful rays generated from a welding operation.

The LCD shielding screen comprises an LCD panel installed in a case for allowing a user to look outside therethrough and shielding harmful rays, a control unit for detecting the harmful rays generated during welding to operate the LCD panel, and a power supply unit for supplying power to the LCD panel and the control unit.

Accordingly, the LCD shielding screen contacts the rear surface of the transparent window of the welding plane, as described above, and is simultaneously fixed to the welding plane using bolts so that the LCD shielding screen is not easily detached from the welding plane.

The above-mentioned connecting structure of LCD shielding screen to the welding plane of the welding mask causes an inconvenience in replacing the LCD shielding screen with a new one. That is, when the LCD shielding screen, which is damaged, needs to be replaced with a new one or the transparent window installed in front of the LCD shielding screen, which is used for a long time, needs to be replaced with a new one, the LCD shielding screen must be separated from the welding plane, thereby causing an inconvenience in loosening and fastening a plurality of the bolts. Accordingly, an improved connecting structure of an LCD shielding screen for a welding mask has been required.

### SUMMARY OF THE INVENTION

Therefore, the present invention has been made in view of the above problems, and it is an object of the present invention to provide a connecting structure of an LCD shielding screen for a welding mask, in which the LCD shielding screen is easily attached to and detached from a welding plane of the welding mask and the LCD shielding screen is safely connected to the welding plane.

In accordance with the present invention, the above and other objects can be accomplished by the provision of a connecting structure of an LCD shielding screen for a welding mask, in which the LCD shielding screen for protecting user's eyes from harmful rays generated during a welding operation is connected to a welding plane having a transparent window formed through the front surface thereof for covering a user's whole face, comprising: hook protrusions extended outwardly from both symmetric terminals of the LCD shielding screen; and rotary connecting pieces axially installed at both sides of the transparent window of the welding plane so that the rotary connecting pieces are connected to the corresponding hook protrusions of the LCD shielding screen.

Preferably, each of the connecting pieces may comprise bending planes formed on the upper end thereof so that the bending planes contact the hook protrusion under the condition that the bending planes cover the hook protrusion when the connecting piece is rotated; and connecting protrusions formed on the inner walls of the bending planes corresponding to the hook protrusion. Alternatively, preferably, each of the connecting pieces may comprise hook protrusion insertion holes having a designated size formed therethrough so that the hook protrusions are respectively inserted into the hook protrusion insertion holes when the connecting piece is rotated.

Further, preferably, a receiving portion for fixing the LCD shielding screen to prevent the movement of the LCD shielding screen may be protruded from the outer circumference of the transparent window of the welding plane at the inside of the rotary connecting pieces.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a welding mask employing a connecting structure of an LCD shielding screen in accordance with one embodiment of the present invention;

FIG. 2 is a rear view of the welding mask employing the connecting structure of the LCD shielding screen in accordance with one embodiment of the present invention;

FIG. 3 is a sectional view of the welding mask employing the connecting structure of the LCD shielding screen in accordance with one embodiment of the present invention;

FIG. 4 is a rear view of a welding mask employing a connecting structure of an LCD shielding screen in accordance with another embodiment of the present invention; and

FIG. 5 is a sectional view of the welding mask employing the connecting structure of the LCD shielding screen in accordance with another embodiment of the present invention.

### DESCRIPTION OF THE PREFERRED EMBODIMENTS

Now, preferred embodiments of the present invention will be described in detail with reference to the annexed drawings.

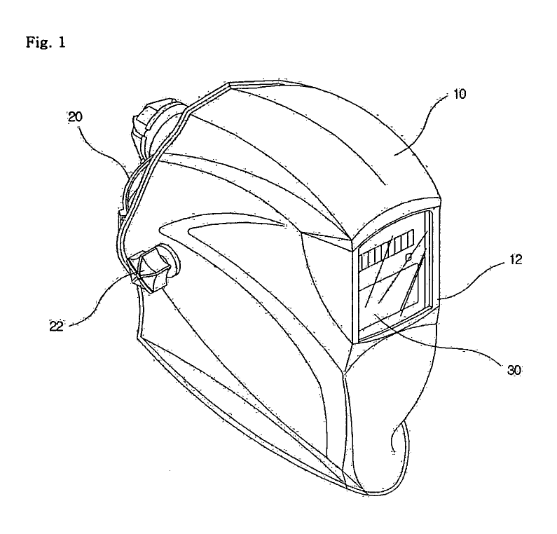

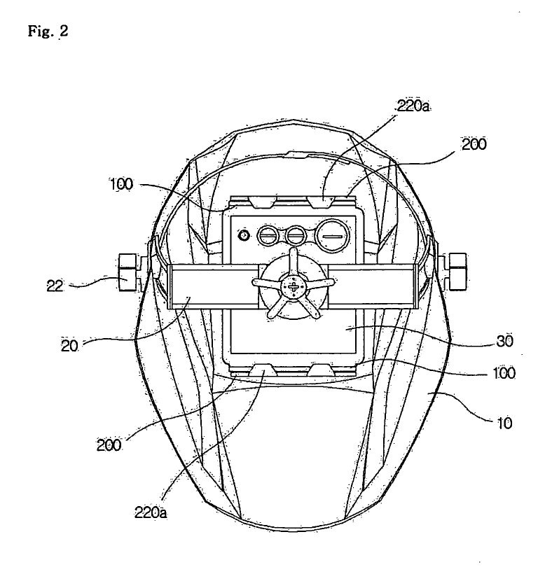

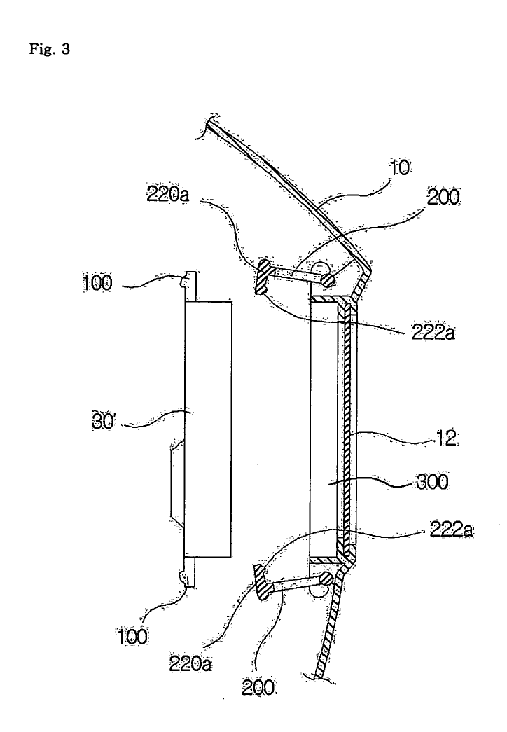

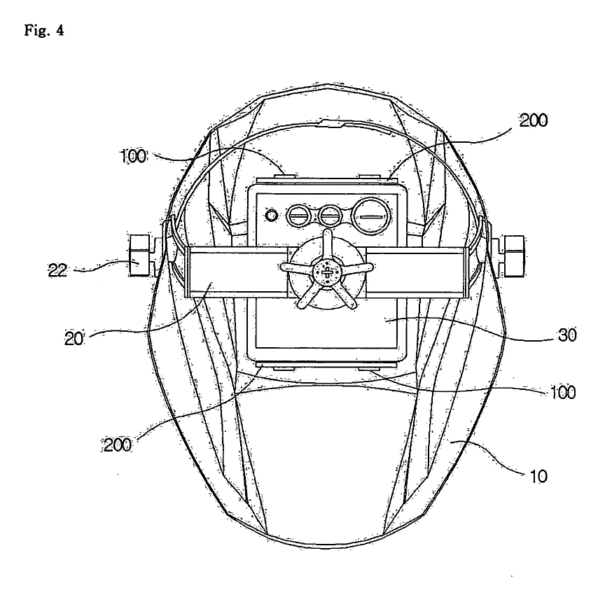

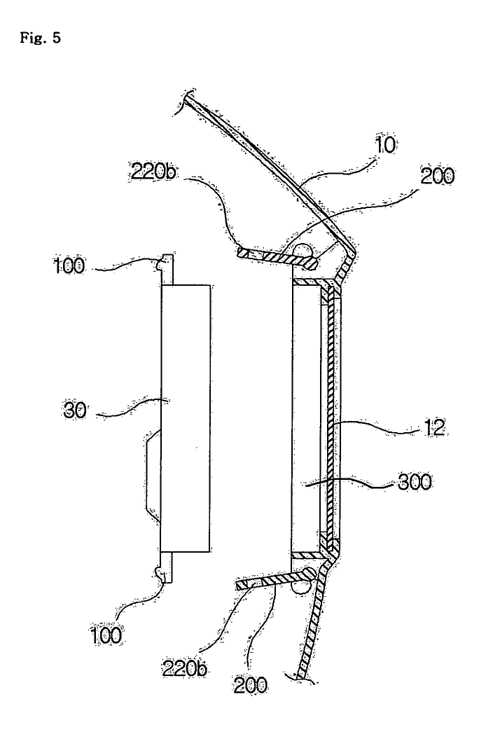

FIG. 1 is a perspective view of a welding mask employing a connecting structure of an LCD shielding screen in accordance with one embodiment of the present invention, FIG. 2 is a rear view of the welding mask employing the connecting structure of the LCD shielding screen in accordance with one embodiment of the present invention, and FIG. 3 is a sectional view of the welding mask employing the connecting structure of the LCD shielding screen in accordance with one embodiment of the present invention. FIG. 4 is a rear view of a welding mask employing a connecting structure of an LCD shielding screen in accordance with another embodiment of the present invention, and FIG. 5 is a sectional view of the welding mask employing the connecting structure of the LCD shielding screen in accordance with another embodiment of the present invention.

As shown in FIGS. 1 to 5, a connecting structure of an LCD shielding screen for a welding mask of the present invention comprises hook protrusions 100 formed on both terminals of an LCD shielding screen 30 such that the hook protrusions 100 face each other, connecting pieces 200 formed on both sides of a transparent window 12 of a welding plane 10 such that the connecting pieces 200 face each other, and a receiving portion 300 protruded from the rear surface of the welding plane 10 at the inside of the connecting pieces 200.

The welding mask employing the connecting structure of the LCD shielding screen of the present invention comprises the welding plane 10 having a transparent window 12 formed through the front surface thereof for covering a user's whole face, a wearable band 20 put on by a user at his/her head and connected to the welding plane 10 using a rotary shaft 22 for rotating the welding plane 10 up and down at a designated angle, and the LCD shielding screen 30 installed in the rear of the transparent window 12 of the welding plane 10 for protecting user's eyes from harmful rays generated from a welding operation.

The LCD shielding screen 30 comprises an LCD panel installed in a case for allowing a user to look outside therethrough and shielding harmful rays, a control unit for detecting the harmful rays generated during welding to operate the LCD panel, and a power supply unit for supplying power to the LCD panel and the control unit.

The hook protrusions 100 are protruded from both terminals of the LCD shielding screen 30.

Preferably, front ends of rear portions of the hook protrusions 100 are extended and projected so that the LCD shielding screen 30 is connected to the receiving portion 300 of the welding plane 10. The projecting parts of the hook protrusions 100 face backward. That is, in order to allow the connecting pieces 200 to be latched onto the projecting parts of the hook protrusions 100, it is preferably that the projecting parts of the hook protrusions 100 face backward.

The hook protrusion 100 protruded from each of both terminals of the LCD shielding screen 30 can be a single unit or be divided into at least two units correspondingly to each of the connecting pieces 200.

The rotary connecting pieces 200 are axially installed at both sides of the transparent window 12 of the welding plane 10 so that the connecting pieces 200 are connected to the hook protrusions 100 of the LCD shielding screen 30.

These connecting pieces 200 may have two shapes. As one shape, as shown in FIGS. 2 and 3, each of the connecting pieces 200 has bending planes 220a formed on the upper end thereof so that the bending planes 220a contact the hook protrusion 100 under the condition that the bending planes 220a cover the hook protrusion 100 when the connecting piece 200 is rotated, and connecting protrusions 222a formed on the inner walls of the bending planes 220a corresponding to the hook protrusion 100. As the other shape, as shown in FIGS. 4 and 5, each of the connecting pieces 200 has hook protrusion insertion holes 220b having a designated size formed therethrough so that the hook protrusions 100 are respectively inserted into the hook protrusion insertion holes 220b when the connecting piece 200 is rotated.

That is, the LCD shielding screen 30 can be fixedly connected to or separated from the welding plane 10 by rotating the connecting pieces 200 against the hook protrusions 100 formed at both terminals of the LCD shielding screen 30.

Although the embodiments of the present invention describe the hook protrusions 100 formed at both sides of the LCD shielding screen 30 and the connecting pieces 200 formed at both sides of the transparent window 12 of the welding plane 10, the hook protrusions 100 may be formed at four sides of the LCD shielding screen 30 and the connecting pieces 200 may be formed at four sides of the transparent window 12 of the welding plane 10.

The receiving portion 300 serves to fix the LCD shielding screen 30 connected to the welding plane 10 so as to prevent the movement of the LCD shielding screen 30, and is protruded backwardly from the outer circumference of the transparent window 12 of the welding plane 10. Here, the receiving portion 300 is located at the inside of the connecting pieces 200 such that the receiving portion 300 cannot disturb the rotation of the connecting pieces 200.

The above structure allows the connecting pieces 200, formed at both sides of the transparent window 12 of the welding plane 10, to be rotated under the condition that the LCD shielding screen 30 is connected to the receiving portion 300 formed in the rear of the transparent window 12 of the welding plane 10, thereby connecting the connecting pieces 200 to the hook protrusions 100. Consequently, it is possible to safely and simply attach and detach the LCD shielding screen 30 to and from the welding plane 10 without the movement of the LCD shielding screen 30.

As apparent from the above description, the present invention provides a connecting structure of an LCD shielding screen for a welding mask, in which the LCD shielding screen is easily attached to and detached from a welding plane of the welding mask by connection structures between hook protrusions formed at both terminals of the LCD shielding screen and connecting pieces formed in the rear of a transparent window of the welding plane, and the LCD shielding screen is safely connected to the welding plane by a receiving portion to which the LCD shielding screen is firmly attached without movement.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A connecting structure of an LCD shielding screen for a welding mask, in which the LCD shielding screen for protecting user's eyes from harmful rays generated during a welding operation is connected to a welding plane having a transparent window formed through the front surface thereof for covering a user's whole face, comprising:
hook protrusions extended outwardly from both symmetric terminals of the LCD shielding screen; and
rotary connecting pieces axially installed at both sides of the transparent window of the welding plane so that the rotary connecting pieces are connected to the corresponding hook protrusions of the LCD shielding screen.

2. The connecting structure as set forth in claim 1, wherein each of the connecting pieces comprises:
bending planes formed on the upper end thereof so that the bending planes contact the hook protrusion under the condition that the bending planes cover the hook protrusion when the connecting piece is rotated; and
connecting protrusions formed on the inner walls of the bending planes corresponding to the hook protrusion.

3. The connecting structure as set forth in claim 1, wherein each of the connecting pieces comprises hook protrusion insertion holes having a designated size formed therethrough so that the hook protrusions are respectively inserted into the hook protrusion insertion holes when the connecting piece is rotated.

4. The connecting structure as set forth in claim 2, wherein a receiving portion for fixing the LCD shielding screen to prevent the movement of the LCD shielding screen is protruded from the outer circumference of the transparent window of the welding plane at the inside of the rotary connecting pieces.

5. The connecting structure as set forth in claim 3, wherein a receiving portion for fixing the LCD shielding screen to prevent the movement of the LCD shielding screen is protruded from the outer circumference of the transparent window of the welding plane at the inside of the rotary connecting pieces.
